(19) United States
(12) Patent Application Publication
(10) Pub. No.: US 2014/0149800 A1
(43) Pub. Date: May 29, 2014

(54) TEST METHOD AND TEST CONTROL APPARATUS

(71) Applicant: FUJITSU LIMITED, Kawasaki-shi (JP)

(72) Inventors: Shizuka NISHIMAKI, Yokohama (JP); Shinsuke TERANISHI, Yokohama (JP)

(73) Assignee: FUJITSU LIMITED, Kawasaki-shi (JP)

(21) Appl. No.: 14/068,019

(22) Filed: Oct. 31, 2013

(30) Foreign Application Priority Data
Nov. 29, 2012 (JP) 2012-261729

(51) Int. Cl. G06F 11/22

(52) U.S. Cl. CPC G06F 11/2273
USPC 714/40

(57) ABSTRACT

Provided is a method for testing an apparatus including a first to third processors, a first circuit that connects the first and second processors, and a second circuit that connects the second and third processors. The method includes generating a test instruction sequence by prepending an additional instruction sequence to a certain instruction sequence which includes an instruction(s) for controlling the apparatus to execute a process using the first circuit. The additional instruction sequence does not change an operation result of an instruction included in the certain instruction sequence. The test instruction sequence includes an instruction(s) for controlling the apparatus to execute a process using the second circuit. The test method includes judging whether the first and second circuits are faulty, by controlling the apparatus to execute the test instruction sequence from a beginning of the certain instruction sequence, and from a beginning of the additional instruction sequence, respectively.

### CROSS-REFERENCE TO RELATED APPLICATION

This application is based upon and claims the benefit of priority of the prior Japanese Patent Application No. 2012-261729, filed on Nov. 29, 2012, the entire contents of which are incorporated herein by reference.

### FIELD

The embodiment discussed herein is related to a test method of an information processing device.

### BACKGROUND

In an information processing device where a plurality of processors operate in parallel, accesses to the same address within a register are redundantly made when a register file is read by executing a succeeding operation instruction after a write of a preceding executed operation instruction has been made to the register file. When accesses are redundantly made to the same address within a register, a register conflict occurs, and a succeeding operation instruction waits until a write process of a preceding executed instruction is complete. As a result, a delay of parallel processing occurs. To avoid a register conflict, applying a bypass circuit in an information processing device is known. The bypass circuit enables a processor that executes a succeeding operation instruction to use an operation result before a processor that executes a preceding operation instruction writes an operation result to a register file.

With the recent shrinkage and complexity of circuits, a hardware fault has been caused by a minute electric condition in some cases. Moreover, a fault sometimes occurs in a unique instruction sequence. When a fault occurs in a bypass circuit, a delay of parallel processing, a data read error, or the like can possibly occur. To detect a fault on the periphery of a processor, a random test instruction sequence is generated, and a noise caused by a minute electric condition or a fault that occurs in a unique instruction sequence is identified.

Related techniques include a method for generating an instruction sequence that causes a pipeline interlock in order to examine a pipeline mechanism of processors. A technique for automatically generating a test instruction sequence that causes an interlock, for notifying a succeeding operation instruction of a register used by a preceding executed operation instruction, and for causing a register used by the succeeding operation instruction to be used redundantly with a register used by the preceding executed operation instruction is known (for example, see Patent Document 1).
[Patent Document 1] Japanese Laid-open Patent Publication No. 2001-222442

### SUMMARY

According to an aspect of the embodiment, a method for testing an apparatus is provided. The apparatus includes a first processor, a second processor, a third processor, a first circuit that connects the first and the second processor, and a second circuit that connects the second and the third processor. The test method includes generating, by a testing processor which is one of the first to third processors or another processor, a test instruction sequence by prepending an additional instruction sequence to a certain instruction sequence which includes one or more instructions for controlling the apparatus to execute a process using the first circuit. The additional instruction sequence does not change an operation result of an instruction included in the certain instruction sequence. The test instruction sequence includes one or more instructions for controlling the apparatus to execute a process using the second circuit. The test method includes judging, by the testing processor, whether the first circuit is faulty, by controlling the apparatus to execute the test instruction sequence from a beginning of the certain instruction sequence included in the test instruction sequence. The test method includes judging, by the testing processor, whether the second circuit is faulty, by controlling the apparatus to execute the test instruction sequence from a beginning of the additional instruction sequence included in the test instruction sequence.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B illustrate an example of a test method;

FIG. 2 illustrates an example of an information processing device;

FIG. 3 illustrates an example of a hardware configuration of the information processing device;

FIG. 4 is a flowchart illustrating an example of a process executed in a first test using a test instruction sequence;

FIG. 5A illustrates an example of a test for which a memory address 401 is specified as a test start address;

FIG. 5B illustrates an example of a test for which a memory address 402 is specified as a test start address;

FIG. 5C illustrates an example of a test for which a memory address 403 is specified as a test start address;

FIG. 5D illustrates an example of a test for which a memory address 404 is specified as a test start address;

FIG. 6 is a flowchart illustrating an example of a process executed in a second test using a test instruction sequence;

FIG. 7 is a flowchart illustrating an example of generating a test instruction sequence;

FIG. 8 is a flowchart illustrating an example of a test control method using a test instruction sequence;

FIG. 9 is a flowchart illustrating a process for making a comparison between an operation result of a test instruction sequence and a predicted value; and

FIG. 10 illustrates an example of test result data.

### DESCRIPTION OF EMBODIMENT

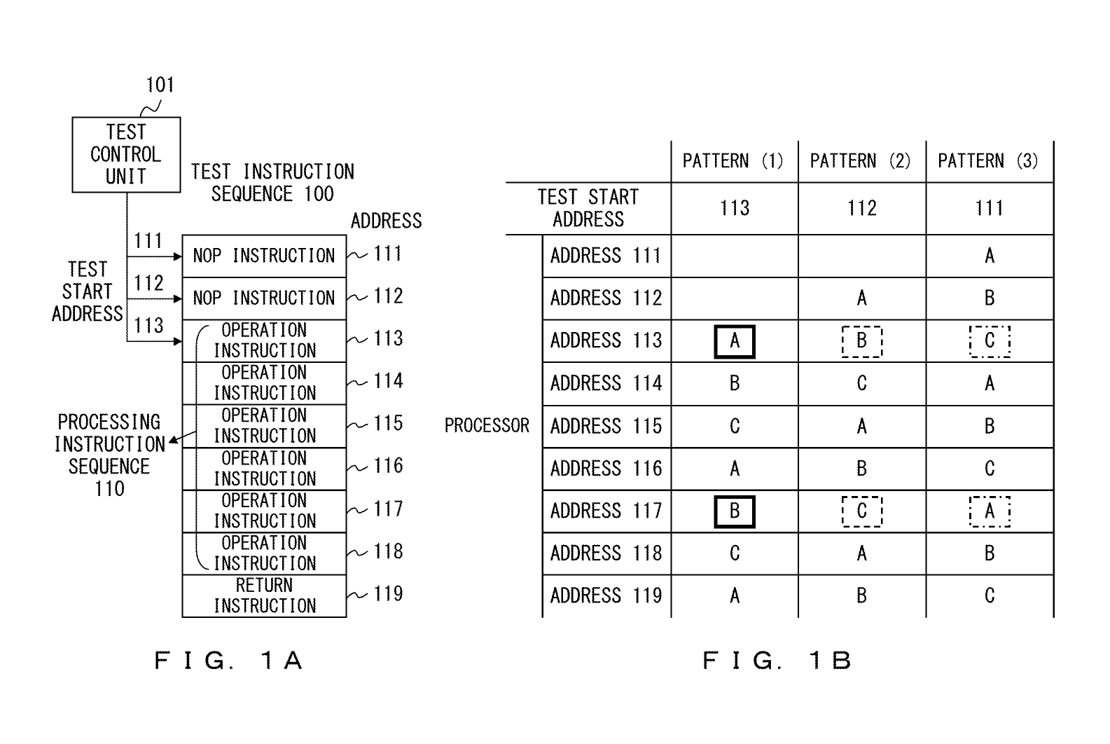

An embodiment is described in detail below with reference to the drawings. FIGS. 1A and 1B illustrate an example of a test method. FIG. 1A illustrates a test instruction sequence 100 and a test control unit 101. The test instruction sequence 100 is an instruction sequence that includes NOP instructions at memory addresses 111 and 112, a processing instruction sequence 110 that includes operation instructions respectively at memory addresses 113-118, and a return instruction at a memory address 119. The NOP (No Operation) instructions are instructions that do not execute any processes and exert no influences on other operation instructions. The operation instructions stored at the memory addresses 113-118 are an operation instruction sequence for detecting a fault that occurs between particular processors. For simplification, the operation instruction sequence for detecting a fault that occurs between particular processors is referred to as a “processing instruction sequence”.

A plurality of processors of a pipeline structure are interconnected by bypass circuits, and able to smoothly execute parallel processing even when operation instructions redundantly make an access to the same address within a register. A case where operation instructions, as a combination, stored at the memory addresses 113 and 117 in the processing instruction sequence 110 redundantly make an access to a particular address within a register is described below as an example. In this case, when a test instruction sequence including the processing instruction sequence 110 is executed, a circuit that connects an processor for executing the operation instruction stored at the memory address 113 and an processor for executing the operation instruction stored at the memory address 117 is used.

The test instruction sequence includes at least one NOP instruction at the beginning of the processing instruction sequence. Moreover, the NOP instruction may be replaced with another operation instruction as long as the operation instruction does not interfere with the processing instruction sequence, does not conflict with a register used by the processing instruction sequence, and exerts no influence on an operation result of the processing instruction sequence. The return instruction is an operation instruction that returns the operation result of the processing instruction sequence to the test control unit, and also returns the process to the test control unit.

The test control unit 101 issues a test start instruction as an instruction for causing a plurality of processors to execute the test instruction sequence. The test start instruction includes a branch instruction for specifying a particular memory address within the test instruction sequence as an address at which a test is started. The address at which the test is started is hereinafter referred to as a “test start address” in some cases. The branch instruction is able to specify a memory address of a NOP instruction within the test instruction sequence or a memory address at the beginning of the processing instruction sequence as a test start address. For example, if the test control unit 101 specifies the memory address 113 as a test start address, a plurality of processors execute the test instruction sequence 100 starting at the operation instruction at the beginning of the processing instruction sequence 110. If the test control unit 101 specifies the memory address 112 as a test start address, the plurality of processors execute the NOP instruction stored at the memory address 112 and its subsequent instructions. If the test control unit 101 specifies the memory address 111 as a test start address, the plurality of processors execute the NOP instruction stored at the memory address 111 and its subsequent instructions.

In the example of FIG. 1, the single test instruction sequence 100 is available as instruction sequences in the following three patterns by specifying a test start address with a branch instruction.

(1) A pattern in which the plurality of processors execute the processing instruction sequence 110 starting at the operation instruction at the beginning of the processing instruction sequence 110, which is stored at the memory address 113.

(2) A pattern in which the plurality of processors execute the processing instruction sequence 110 starting at the NOP instruction stored at the memory address 112.

(3) A pattern in which the plurality of processors execute the processing instruction sequence 110 at the NOP instruction stored at the memory address 111.

In the instruction sequences in the patterns (1)-(3), the order of operation instructions does not change the processing instruction sequence.

FIG. 1B illustrates an example of an assigned state of the processors. The assigned state of the processors is an example of the processors A-C to which the operation instructions stored at the memory addresses are assigned by pipeline processing.

In a column of the pattern (1) illustrated in FIG. 1B, the memory address 113 is specified as a test start address. Accordingly, the operation instructions at the memory addresses are assigned to the processors as follows. In the example of the pattern (1), the NOP instructions stored at the memory address 111 and 112 are not executed by the processors.
operation instruction at the memory address 113: processor A

operation instruction at the memory address 114: processor B

operation instruction at the memory address 115: processor C

operation instruction at the memory address 116: processor A

operation instruction at the memory address 117: processor B

operation instruction at the memory address 118: processor C

return instruction at the memory address 119: processor A

In a column of the pattern (2), the memory address 112 is specified as a test start address. Accordingly, the operation instructions at the memory addresses are assigned to the processors as follows. In the example of the pattern (2), the NOP instruction stored at the memory address 111 is not executed by the processor.

NOP instruction at the memory address 112: processor A

operation instruction at the memory address 113: processor B

operation instruction at the memory address 114: processor C

operation instruction at the memory address 115: processor A

operation instruction at the memory address 116: processor B

operation instruction at the memory address 117: processor C

operation instruction at the memory address 118: processor A

return instruction at the memory address 119: processor B

In a column of the pattern (3), the memory address 111 is specified as a test start address. Accordingly, the operation instructions at the memory addresses are assigned to the processors as follows.

NOP instruction at the memory address 111: processor A

NOP instruction at the memory address 112: processor B

operation instruction at the memory address 113: processor C

operation instruction at the memory address 114: processor A

operation instruction at the memory address 115: processor B

operation instruction at the memory address 116: processor C

operation instruction at the memory address 117: processor A

operation instruction at the memory address 118: processor B

return instruction at the memory address 119: processor C

Note that the branch instruction for specifying a test start address includes an instruction for canceling all operation instructions currently being executed before the processors are caused to execute the test instruction sequence. The branch instruction further includes a pipeline flush instruction. Thus, the test instruction sequence is able to sequentially assign a process to the processors starting at a stipulated unit each time. In the example of FIG. 1B, the operation instruction at the beginning of the patterns (1)-(3) is assigned to the processor A. The instructions are sequentially assigned to the processors B and C in this order subsequently to the processor A.

The operation instructions stored at the memory addresses 113 and 117 are respectively assigned to the processors A and B as indicated by solid-line frames in the case of the pattern (1). Accordingly, when the instruction sequence of the pattern (1) is used, a bypass circuit between the processors A and B is used. If a fault does not occur in the bypass circuit, the processing instruction sequence properly ends the process, and returns a particular operation result to the test control unit. Alternatively, if a fault occurs in the bypass circuit, the processing instruction sequence is unable to properly end the process, and returns an abnormal value or an error value. For example, when a fault occurs in the bypass circuit between the processors A and B and the processing instruction sequence is not properly processed, a particular error value is output as an operation result of the processing instruction sequence 110. When an operation result that is different from a value predicted as the operation result of the processing instruction sequence 110 is returned, it is determined that a fault occurs in the bypass circuit between the processors A and B.

Next, when the memory address 112 is specified as a test start address, the instruction sequence used for the test includes the NOP instruction stored at the memory address 112 at the beginning of the processing instruction sequence 110 as described in the pattern (2). In the case of the pattern (2), the operation instructions stored at the memory addresses 113 and 117 are respectively assigned to the processors B and C as indicated by dotted-line frames. Accordingly, when the instruction sequence in the pattern (2) is executed, a bypass circuit between the processors B and C is used. Unlike the pattern (1), the NOP instruction is stored at the beginning of the instruction sequence in the pattern (2). The NOP instruction is an operation instruction that exerts no influence on the operation result of the processing instruction sequence. Accordingly, the pattern (2) is an operation instruction sequence effective in detecting a fault in the bypass circuit between the processors B and C.

When the memory address 111 is specified as a test start address, the instruction sequence used for the test includes the NOP instructions stored at the memory addresses 111 and 112 at the beginning of the processing instruction sequence 110 as described in the pattern (3). The operation instructions stored at the memory addresses 113 and 117 are assigned to the processors C and A as indicated by one-dot-one-dash line frames in the case of the pattern (3). Accordingly, when the instruction sequence in the pattern (3) is executed, a bypass circuit between the processors C and A is used.

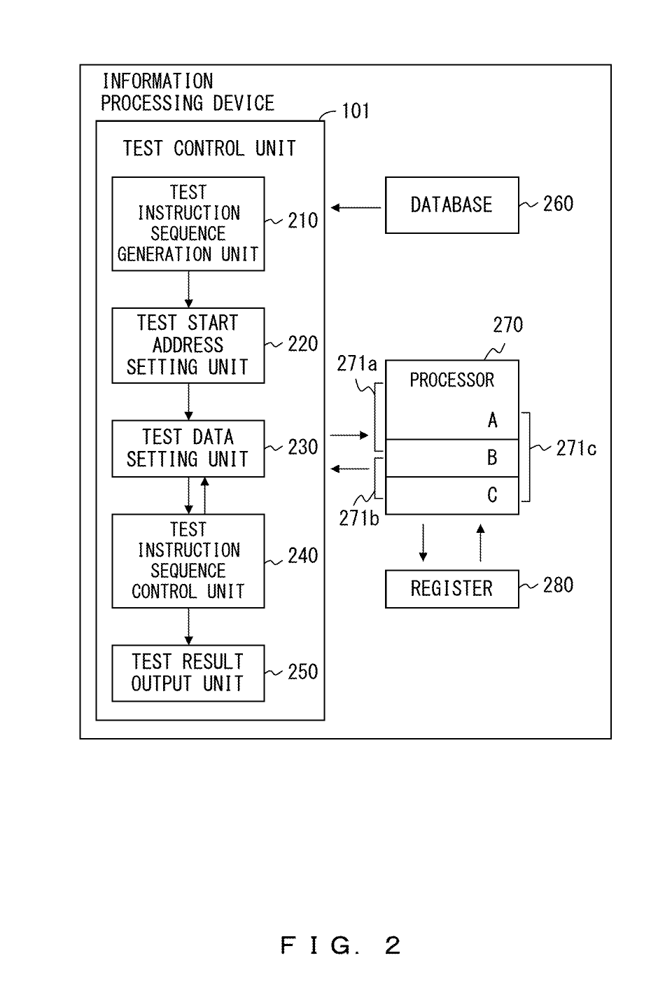

FIG. 2 illustrates an example of an information processing device. The information processing device illustrated in FIG. 2 includes the test control unit 101, a database 260, the plurality of processors 270, and a register 280. The test control unit 101 includes a test instruction sequence generation unit 210, a test start address setting unit 220, a test data setting unit 230, a test instruction sequence control unit 240, and a test result output unit 250. The plurality of processors 270 have bypass circuits 271a-271c. In the example illustrated in FIG. 2, the number of processors is three. Assume that the number of processors included in the information processing device is arbitrarily changed depending on an implementation. Also assume that the number of bypass circuits that connect the processors varies depending on the number of processors included in the information processing device.

The test instruction sequence generation unit 210 generates a test instruction sequence. The test instruction sequence includes at least one NOP instruction at the beginning of a processing instruction sequence, and further includes a processing instruction sequence subsequent to the NOP instruction, and a return instruction. The test instruction sequence is generated by prepending NOP instruction sequence to the processing instruction. The test instruction sequence generation unit 210 obtains the processing instruction sequence from the database 260. The database 260 stores a plurality of processing instruction sequences, and a predicted value that corresponds to each of the processing instruction sequences and is an operation result predicted when a circuit is normal. Moreover, the database 260 may store an error value as an operation result, which corresponds to each of the processing instruction sequences at the time of a fault, as a replacement for the predicted value, or may store both the predicted value and the error value. The predicted value and the error value are used to determine whether or not a circuit is normal by making a comparison between an actual operation result obtained by causing processors to execute a processing instruction sequence and the predicted value or the error value. Additionally, the database 260 may store predetermined test environment information used for a test when a processing instruction sequence is executed. The processing instruction sequence, the predicted value, the error value, and the test environment information may be set by an operator depending on a test.

Furthermore, the test instruction sequence generation unit 210 obtains the number of processors included in the information processing device. The number of processors is used to calculate an optimum number of NOP instructions. The test instruction sequence may include at least one NOP instruction. Preferably, the test instruction sequence includes NOP instructions the number of which is smaller than a total number of processors. For example, a case of a test instruction sequence 100′ that is obtained by deleting the NOP instruction at the memory address 111 from the test instruction sequence 100 illustrated in FIG. 1A and includes the NOP instruction at the memory address 112 and the processing instruction sequence is considered. Since the test instruction sequence 100′ includes only one NOP instruction, it is available as the instruction sequence for the tests in the patterns (1) and (2). However, the instruction sequence 100′ is unavailable as the instruction sequence for the test in the pattern (3). Accordingly, an assigned state 120′ of the processors illustrated in FIG. 1B does not have the sequence of the pattern (3). Thus, the test instruction sequence 100′ is effective in detecting a fault of the bypass circuit between the processors A and B as in the pattern (1), and also effective in detecting a fault of the bypass circuit between the processors B and C as in the pattern (2). However, the test instruction sequence 100′ is not effective in detecting a fault of the bypass circuit between the processors C and A. Therefore, to detect a fault with full coverage of the processors, it is preferable that the test instruction sequence 100 conducts the tests in the patterns (1)-(3) for the three processors A-C. To implement this, a test instruction sequence including two NOP instructions is preferable. When the number of processors is n, it is preferable to conduct tests of patterns (1)-(n) in a similar manner. Here, n is an integer equal to or larger than 2. Therefore, it is preferable to use a test instruction sequence including (n−1) of NOP instructions. However, if a test time is desired to be reduced, or if it is proved that a fault does not occur between particular processors, tests are not conducted with full coverage of the processors. In this case, a test instruction sequence in which the number of NOP instructions is adjusted depending on a test desired to be conducted may be used.

The number of processors included in the information processing device, and the database 260 are stored in a memory device or a storage device. The number of processors included in the information processing device may be stored in the database 260. Also the test control unit 101 is stored in the memory device or the storage device.

The test start address setting unit 220 sets a memory address as an initial value of the test start address. The initial value of the test start address indicates a memory address as the test start address, which is specified by a branch instruction, and stored in a predetermined memory or storage device.

Next, the test data setting unit 230 sets data uses for the test. The test data setting unit 230 stores the test instruction sequence generated by the test instruction sequence generation unit 210 in a predetermined memory or storage device. Moreover, the test data setting unit 230 sets the number of processors, a predicted value, predetermined test environment information, a test number, and the like in a predetermined memory, storage device, or register. Additionally, when a test start address is changed, the test data setting unit 230 sets the test start address after being changed as will be described later.

The test instruction sequence control unit 240 issues a test start instruction to cause the plurality of processors 270 to execute a test instruction sequence. Thereafter, the test instruction sequence control unit 240 receives an operation result from the plurality of processors 270. Moreover, the test instruction sequence control unit 240 makes a comparison between the received operation result and a predicted value, and outputs a result of the comparison to the test result output unit 250. Additionally, the test instruction sequence control unit 240 calculates a test start address used when the next test instruction sequence is executed as will be described in detail later. The test start instruction includes a branch instruction. The plurality of processors that have received the test start instruction execute operation instructions by assigning a process of the test instruction sequence to the processors starting at the test start address specified by the branch instruction. Next, the test instruction sequence control unit 240 receives a operation result obtained by executing the test instruction sequence by each of the processors, and makes a comparison between the operation result and the predicted value obtained from the database 260. If the received operation result and the predicted value match, it can be determined that a circuit between predetermined processors is properly running. Alternatively, if the received operation result and the predicted value mismatch, it is determined that a fault occurs in the circuit between the predetermined processors. The test instruction sequence control unit 240 outputs, to the test result output unit 250, a result of the comparison, which is obtained by determining whether or not the circuit is properly running. The test result output unit 250 receives the result of the comparison from the test instruction sequence control unit 240, and outputs the result of the comparison as a test result.

The plurality of processors 270 include processors A-C, which are connected by the bypass circuits 271a-271c. The bypass circuits 271a, 271b, and 271c respectively connect the processors A and B, the processors B and C, and the processors C and A. According to the test start instruction of the test instruction sequence control unit 240, the processors respectively process assigned instructions within the test instruction sequence 100. For example, if the test instruction sequence 100 illustrated in FIG. 1A is executed as the pattern (1), it is determined whether or not a fault occurs in the bypass circuit 271a. Similarly, if the test instruction sequence 100 is executed as the pattern (2), it is determined whether or not a fault occurs in the bypass circuit 271b. Moreover, if the test instruction sequence 100 is executed as the pattern (3), it is determined whether or not a fault occurs in the bypass circuit 271c. The register 280 is suitably used when the test instruction sequence is executed.

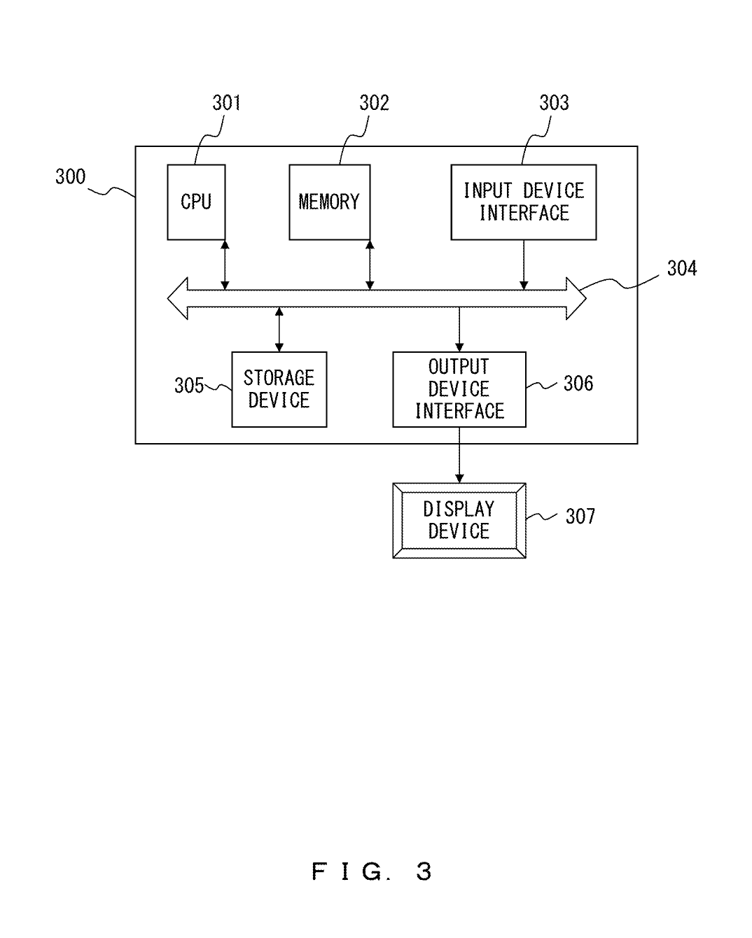

FIG. 3 illustrates an example of a hardware configuration of the information processing device. The hardware configuration illustrated in FIG. 3 is implemented by including the information processing device 300 and a display device 307. The information processing device 300 includes a processor 301, a memory 302, an input device interface 303, a bus 304, a storage device 305, and an output device interface 306. In the example of FIG. 3, the processor is a CPU (Central Processing Unit) 301. However, the information processing device may include an arbitrary control circuit implemented according to an implementation.

The CPU 301 is interconnected with the memory 302, the input device interface 303, the storage device 305, and the output device interface 306 via the bus 304. The CPU 301 executes a program stored in the storage device 305, or a program loaded into the memory 302. The storage device 305 includes a magnetic disk device, an optical disk device, a magneto-optical disk device, or a semiconductor storage device. The storage device 305 also includes a drive device that handles a computer-readable recording medium. As the recording medium handled by the drive device, an arbitrary computer-readable recording medium such as a magnetic tape, a memory card, an optical disc (CD-ROM, DVD-ROM or the like), or a magneto-optical disk (MO, MD or the like) is available. The storage device 305 stores the program for executing processes according to the embodiment, and various types of data used in the embodiment.

The hardware configuration illustrated in FIG. 3 is described next based on the configuration illustrated FIG. 2. The plurality of processors 270 correspond to the CPU 301, which includes the register 280. A program used to implement the process of the test control unit 101 is stored in the memory 302 or the storage device 305. The test control unit 101 includes the test instruction sequence generation unit 210, the test start address setting unit 220, the test data setting unit 230, the test instruction sequence control unit 240, and the test result output unit 250. The test control unit 101 is implemented by the CPU 301. The test instruction sequence generation unit 210 obtains various types of information such as a processing instruction sequence, a predicted value, and the like from the database 260 when it generates a test instruction sequence. The database 260 may be stored in the storage device, or may be an external storage device, not illustrated, via the input device interface 303. Additionally, various types of information such as a processing instruction sequence, a predicted value, and the like may be input by an operator with the use of the input device interface 303 such as a keyboard or a mouse. The test result output unit 250 displays an operation result on the display device 307 via the output device interface 306 when it outputs the operation result.

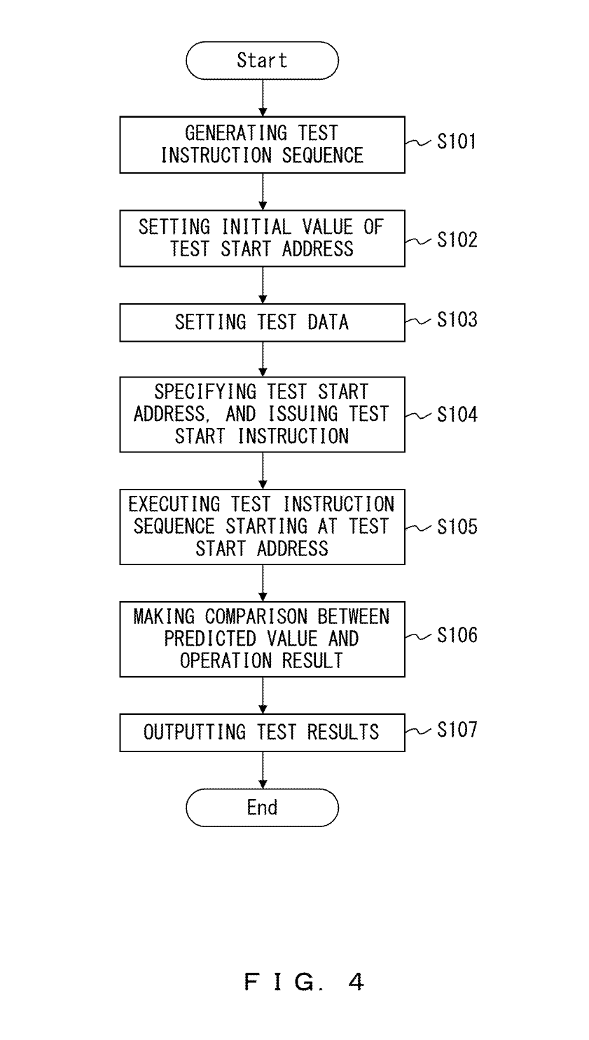

FIG. 4 is a flowchart illustrating an example of the process executed in the first test using a test instruction sequence. The first test is a test for processing a test instruction sequence by specifying one test start address. An example of a series of processes executed in the first test is represented by steps S101-S107. The test control unit executes steps S101-S104, S106 and S107, and the plurality of processors execute step S105.

The test instruction sequence generation unit 210 generates a test instruction sequence (step S101). The test start address setting unit 220 sets a memory address used as an initial value of the test start address (step S102). The test data setting unit 230 sets data used for the test (S103). The data used for the test is a test instruction sequence, the number of processors, a predicted value, predetermined test environment information, a test number, and the like. The test instruction sequence control unit 240 specifies the test start address, and issues a test start instruction (step S104). In the first test, the initial value of the test start address, which is set in S102, is used as the test start address. The plurality of processors 270 execute the test instruction sequence starting at the test start address (step S105). While the test instruction sequence is being executed by the plurality of processors, it is preferable that an interrupt of another operation instruction is not inserted. Accordingly, upon receipt of the test start instruction, the plurality of processors cancel an operation instruction currently being executed, and execute the test instruction sequence with priority. Moreover, after the test control unit issues the test start instruction, it does not execute the process until it receives an operation result. The test instruction sequence control unit 240 receives the operation result, and makes a comparison between the operation result and the predicted value (step S106). The test result output unit 250 obtains a result of the comparison from step S106, and outputs the result of the comparison as a test result (step S107).

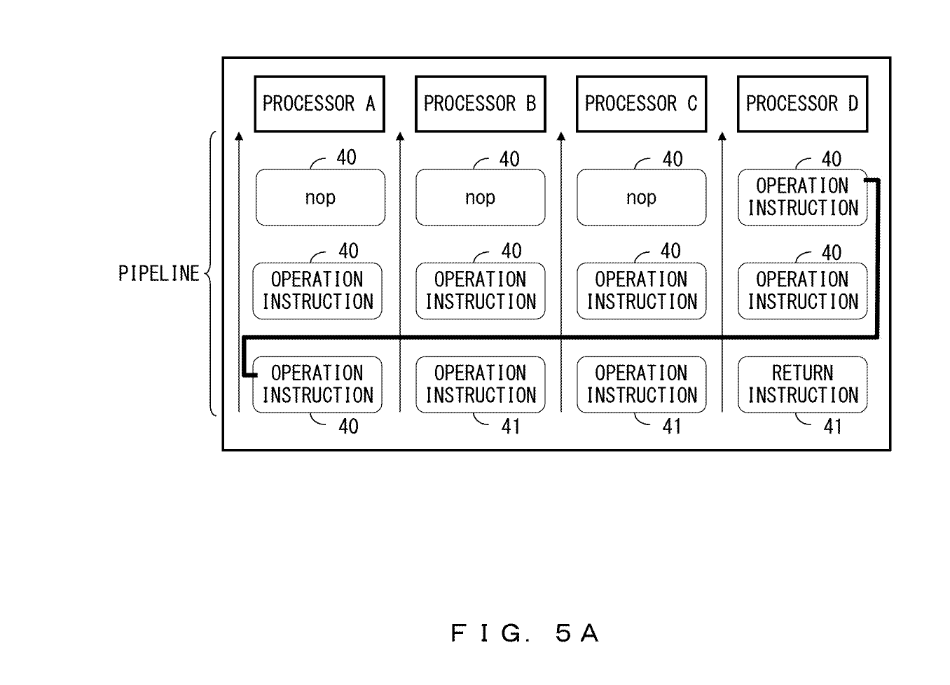

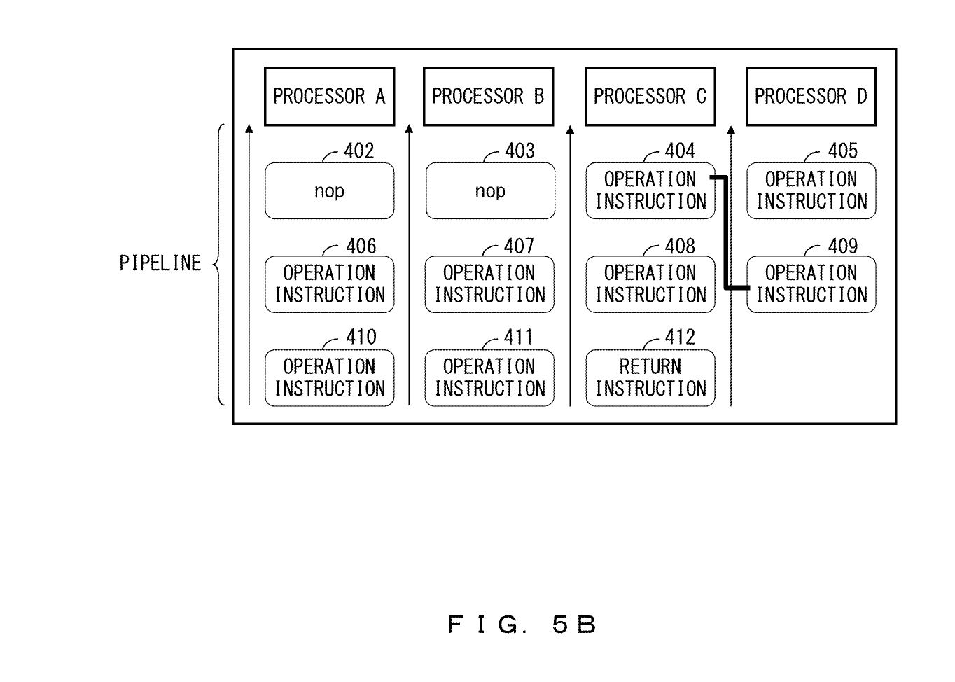

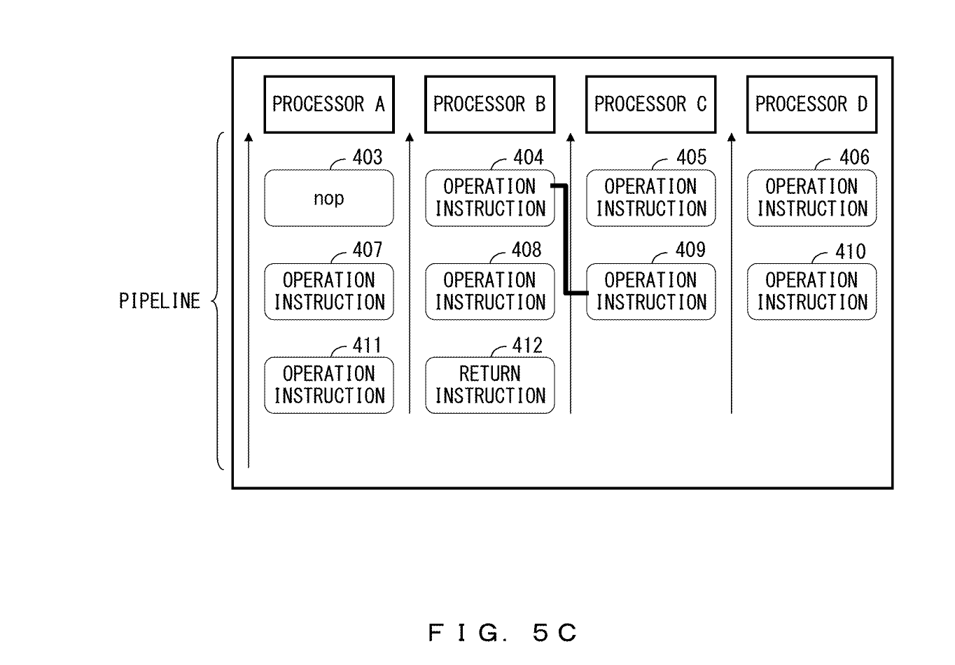

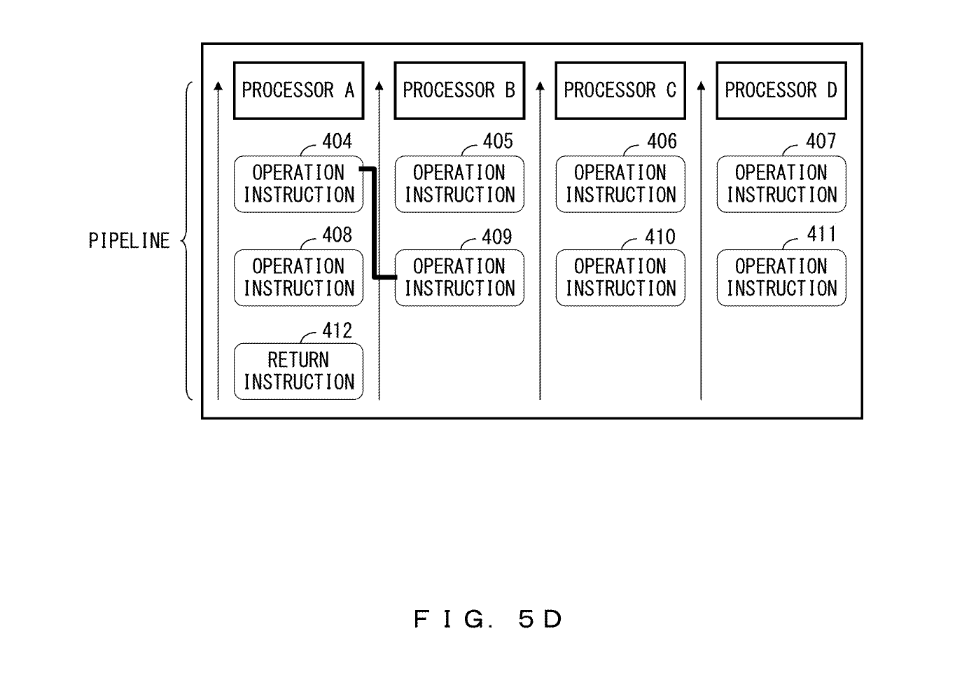

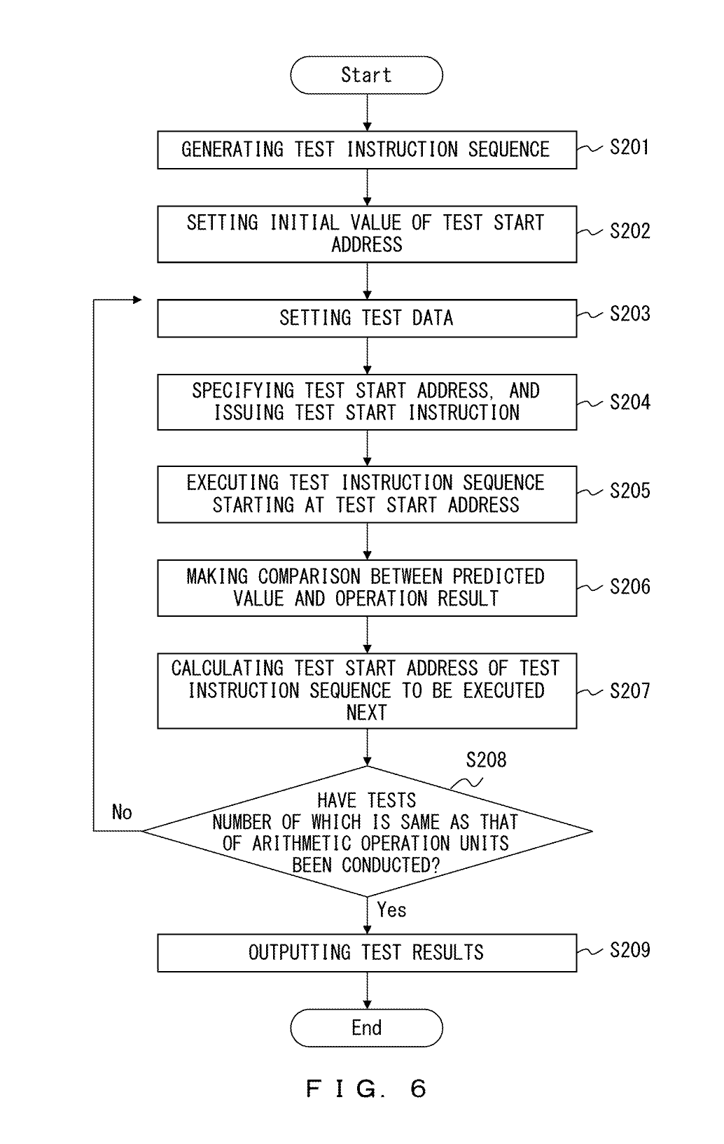

An example of the second test is described with reference to FIGS. 5A-5D and 6. The description of the second test refers to a case where instruction sequences in a plurality of patterns, which are obtained from a test instruction sequence, are executed after the one test instruction sequence is output and test results of the plurality of patterns are collectively obtained. The description of the second test is provided by taking, as an example, a test conducted in an information processing device including four processors A-D.

The following description assumes that a test instruction sequence illustrated in FIG. 5A is generated. Assume that the test instruction sequence generation unit 210 obtains a processing instruction sequence from the database 260 and stores the obtained sequence at memory addresses 404-411. Also assume that the test instruction sequence generation unit 210 decides the number of NOP instructions added to the beginning of the processing instruction sequence to be 3 based on the number of processors, which is 4. In this case, the test instruction sequence is that illustrated in FIG. 5A. In the example of FIG. 5A, the test instruction sequence 400 includes the NOP instructions at memory addresses 401-403, operation instructions, which are the processing instruction sequence, at memory addresses 404-411, and a return instruction at a memory address 412. Assume that the processors that execute the instructions stored at the memory addresses 404 and 409 redundantly make an access to the same address within the register in the test instruction sequence 400 illustrated in FIG. 5A. Moreover, a branch instruction is able to specify the memory address of any of the NOP instructions within the test instruction sequence or the memory address at the beginning of the processing instruction sequence as a test start address. Accordingly, in the test instruction sequence 40, it is possible to specify any of the memory addresses 401-404 as a test start address. As the second test, a test using instruction sequences in the following four patterns is conducted by specifying each of the memory addresses 401-404 as a test start address each time.

(i) A pattern in which the plurality of processors execute the instruction sequence starting at the NOP instruction stored at the memory address 401

(ii) A pattern in which the plurality of processors execute the instruction sequence starting at the NOP instruction stored at the memory address 402

(iii) A pattern in which the plurality of processors execute the instruction sequence starting at the NOP instruction stored at the memory address 403

(iv) A pattern in which the plurality of processors execute the instruction sequence starting at the operation instruction stored at the memory address 404 (the processors do not execute the NOP instructions stored at the memory addresses 401, 402, and 403)

FIG. 6 is a flowchart illustrating an example of the process executed in the second test using the test instruction sequence. As the second test, tests in the patterns (i), (ii), (iii), and (iv) are sequentially executed in this order.

<First Test: Pattern (i)>

As an initial process, the test instruction sequence generation unit 210 generates the test instruction sequence 400 (step S201). The test instruction sequence 400 is a test instruction sequence used in common in the patterns (i) to (iv). Therefore, a process for regenerating the test instruction sequence 400 is not executed in the second and subsequent tests. The test start address setting unit 220 sets the memory address 401 as an initial value of the test start address (step S202). The test data setting unit 230 sets data used for the test (step S203). The data used for the test includes the test instruction sequence 400, the number of processors, a predicted value, predetermined test environment information, a test number, and the like. The test instruction sequence control unit 240 specifies the memory address 401 as the test start address, and issues a test start instruction (step S204). The plurality of processors 270 execute the test instruction sequence starting at the test start address (step S205). In the test in the pattern (i), operation instructions of the test instruction sequence 400 are assigned to the processors A-D as illustrated in FIG. 5A. The processors that execute the instructions stored at the memory addresses 404 and 409 redundantly make an access to the same address within the register. Accordingly, the test in the pattern (i) uses a bypass circuit between the processors D and A. The test instruction sequence control unit 240 receives an operation result of the pattern (i), makes a comparison between the operation result and the predicted value, and determines whether or not a fault occurs in the bypass circuit between the processors D and A (step S206). The test instruction sequence control unit 240 calculates a test start address of the test instruction sequence to be executed next (step S207). The test instruction sequence control unit 240 sets the memory address 402 as the test start address of the test instruction sequence to be executed next. The test instruction sequence control unit 240 determines whether or not tests the number of which is the same as that of the processors have been conducted (step S208). Since the pattern (i) is the first test, tests the number of which is the same as that of the processors, namely, 4 tests have not been conducted yet. Therefore, the determination in step S208 results in “NO”. Then, the process is returned to step S203.

<Second Test: Pattern (ii)>

The test data setting unit 230 sets data used for the test (step S203). The data set here is the test start address, calculated in step S207 in the first test, of the test instruction sequence to be executed next. As a result of the calculation in step S207 in the first test, the test data setting unit 230 sets the memory address 402 as the test start address of the test instruction sequence to be executed next. The same data as the test instruction sequence 400 set in step S203 in the first test, the number of processors, the predicted value, and the predetermined test environment information are used also in the second test. The test instruction sequence control unit 240 specifies the memory address 402 as the test start address, and issues a test start instruction (step S204). The plurality of processors 270 execute the test instruction sequence starting at the test start address (step S205). In the test in the pattern (ii), the operation instructions of the test instruction sequence 400 are assigned to the processors A-D as illustrated in FIG. 5B. The NOP instruction stored at the memory address 401 in the test instruction sequence 400 is not executed by the processor. The processors that execute the instructions stored at the memory addresses 404 and 409 redundantly make an access to the same address within the register. Accordingly, the test in the pattern (ii) uses the bypass circuit between the processors C and D. The test instruction sequence control unit 240 receives an operation result of the pattern (ii), and determines whether or not a fault occurs in the bypass circuit between the processors C and D by making a comparison between the operation result and the predicted value (step S206). The test instruction sequence control unit 240 calculates a test start address of the test instruction sequence to be executed next (step S207). The test instruction sequence control unit 240 sets the memory address 403 as the test start address of the test instruction sequence to be executed next. The test instruction sequence control unit 240 determines whether or not tests the number of which is the same as that of the processors have been conducted (step S208). Since the pattern (ii) is the second test, tests the number of which is the same as that of the processors, namely, 4 tests have not been conducted yet. Accordingly, the determination in step S208 results in “NO”. Then, the process is repeated in and after step S203.

<Third Test: Pattern (iii)>

The test data setting unit 230 sets data used for the test (step S203). The data set here is the test start address, calculated in step S207 in the second test, of the test instruction sequence to be executed next. As a result of the calculation in step S207 in the second test, the test data setting unit 230 sets the memory address 403 as the test start address of the test instruction sequence to be executed next. The same data as the test instruction sequence 400 set in step S203 in the first test, the number of processors, the predicted value, and the predetermined test environment information are used also in the third test. The test instruction sequence control unit 240 specifies the memory address 403 as the test start address, and issues a test start instruction (step S204). The plurality of processors 270 execute the test instruction sequence starting at the test start address (step S205). In the test in the pattern (iii), the operation instructions of the test instruction sequence 400 are assigned to the processors A-D as illustrated in FIG. 5C. The NOP instructions stored at the memory addresses 401 and 402 in the test instruction sequence 400 are not executed by the processors. The processors that execute the instructions stored at the memory addresses 404 and 409 redundantly make an access to the same address within the register. Accordingly, the test in the pattern (iii) uses the bypass circuit between the processors B and C. The test instruction sequence control unit 240 receives a result of the operation of the pattern (iii), and determines whether or not a fault occurs in the bypass circuit between the processors B and C by making a comparison between the result of the operation and the predicted value (step S206). The test instruction sequence control unit 240 calculates a test start address of the test instruction sequence to be executed next (step S207). The test instruction sequence control unit 240 sets the memory address 404 as the test start address of the test instruction sequence to be executed next. The test instruction sequence control unit 240 determines whether or not tests the number of which is the same as that of the processors have been conducted (step S208). Since the pattern (iii) is the third test, tests the number of which is the same as that of the processors, namely, 4 tests have not been conducted yet. Accordingly, the determination in step S208 results in “NO”. Then, the process is repeated in and after step S203.

<Fourth Test: Pattern (iv)>

The test data setting unit 230 sets data used for the test (step S203). The data set here is the test start address, calculated in step S207 in the third test, of the test instruction sequence to be executed next. As a result of the calculation in step S207 in the third test, the test data setting unit 230 sets the memory address 404 as the test start address of the test instruction sequence to be executed next. The same data as the test instruction sequence 400 set in step S203 in the first test, the number of processors, the predicted value, and the predetermined test environment information are used also in the fourth test. The test instruction sequence control unit 240 specifies the memory address 404 as the test start address, and issues a test start instruction (step S204). The plurality of processors 270 execute the test instruction sequence starting at the test start address (step S205). In the test in the pattern (iv), the operation instructions of the test instruction sequence 400 are assigned to the processors A-D as illustrated in FIG. 5D. The NOP instructions stored at the memory addresses 401 and 402 of the test instruction sequence 400 are not executed by the processors. The processors that execute the operation instructions stored at the memory addresses 401 and 402 redundantly make an access to the same address within the register. Accordingly, the test in the pattern (iv) uses the bypass circuit between the processors A and B. The test instruction sequence control unit 240 receives a result of the operation of the pattern (iv), and determines whether or not a fault occurs in the bypass circuit between the processors A and B by making a comparison between the result of the operation and the predicted value (step S206). The test instruction sequence control unit 240 calculates a test start address of the test instruction sequence to be executed next (step S207). The test instruction sequence control unit 240 determines whether or not tests the number of which is the same as that of the processors have been conducted (step S208). Since the pattern (iv) is the fourth test, tests the number of which is the same as that of the processors, namely, 4 tests have been conducted. Accordingly, the determination in step S208 results in “YES”. Then, the process proceeds to step S209.

The test result output unit 250 receives results of the comparison performed in step S206 in all the tests, and outputs the results as test results (step S209). Upon termination of step S209, the test control unit ends the process.

In FIG. 6, the pattern (i) is assumed to be the first test, and the tests in the patterns (ii), (iii), and (iv) are sequentially conducted as the example of the second test. However, the embodiment is not limited to this one. The test in the pattern (iv) may be initially executed, and the tests in the patterns (iii), (ii), and (i) may be executed in this order.

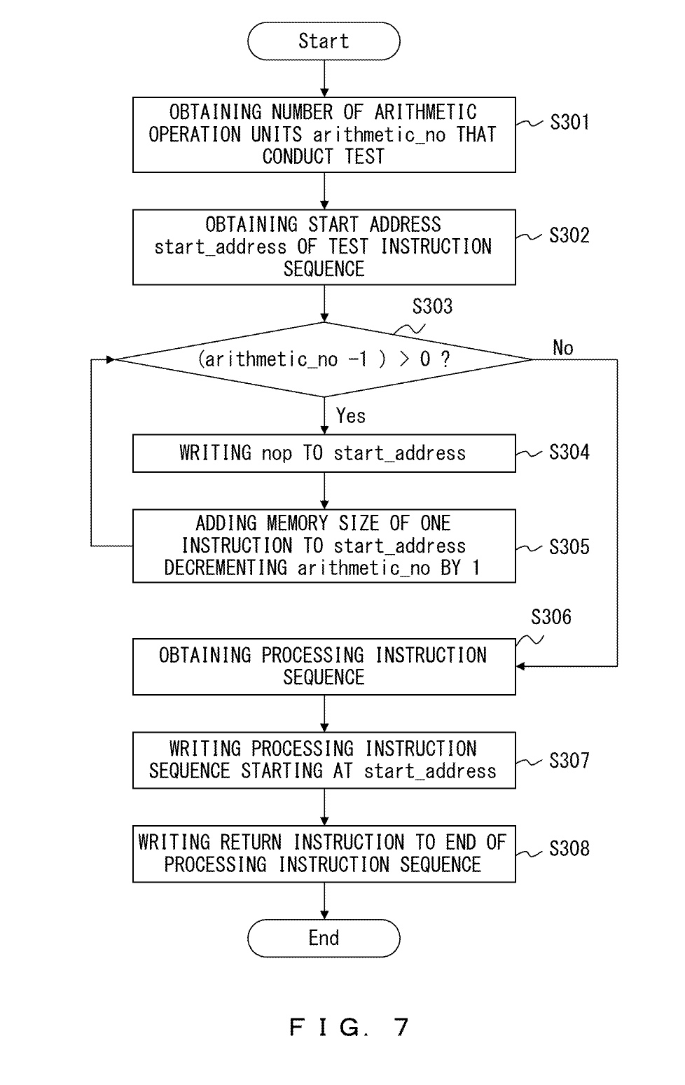

FIG. 7 is a flowchart illustrating an example of generating a test instruction sequence. FIG. 7 represents further details of the process of step S201 in FIG. 6. The test instruction sequence generation unit 210 obtains, from the database 260, arithmetic_no indicating the number of processors that conduct a test (step S301). The obtained arithmetic_no is stored in a predetermined memory or storage device. The test instruction sequence generation unit 210 obtains an address start_address indicating a memory address at the beginning of a test instruction sequence (step S302). The obtained memory address at the beginning of the start instruction sequence is an arbitrary address used to generate the test instruction sequence. The obtained address start_address is stored in a predetermined memory or storage device.

Steps S303-S305 represent a process for writing a NOP instruction to the test instruction sequence. The test instruction sequence generation unit 210 decrements arithmetic_no by 1, and determines whether or not the decremented value is larger than 0 (step S303). If the value obtained by decrementing arithmetic_no by 1 is larger than 0, the test instruction sequence generation unit 210 writes the NOP instruction to the address start_address (S304 if “YES” in step S303). The test instruction sequence control unit 240 adds a memory size used to store one NOP instruction to the address start address. Moreover, the test instruction sequence control unit 240 decrements arithmetic_no by 1. The test instruction sequence control unit 240 returns the address start address to which the memory size used to store one NOP instruction is added, and the decremented arithmetic_no to step S303. Then, the process in and after step S303 is repeated.

Steps S306-S308 represent a process for writing a processing instruction sequence and a return instruction to the test instruction sequence. When the value obtained by decrementing arithmetic_no by 1 and the results is 0, the test instruction sequence control unit 240 obtains a processing instruction sequence from the database 260 (step S306 if “NO” in step S303). The test instruction sequence generation unit 210 writes the processing instruction sequence to the address start_address calculated last in step S305 (step S307). Then, the test instruction sequence generation unit 210 writes the return instruction to the end of the processing instruction sequence. Upon termination of step S308, the test instruction sequence generation unit 210 ends the process.

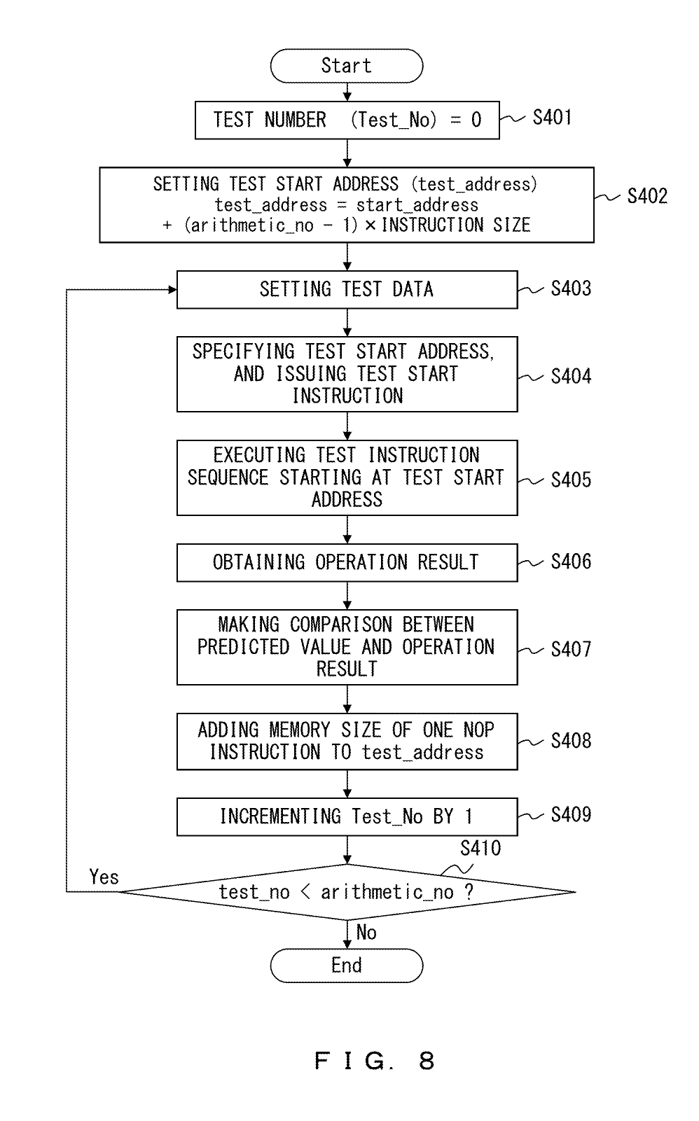

FIG. 8 is a flowchart illustrating an example of the test control method using the test instruction sequence. FIG. 8 represents further details of steps S202-S208 in FIG. 6.

The test start address setting unit 220 sets Test_No indicating a test number to 0 (step S401). The test number is a number attached in association with a test start address. The test start address setting unit 220 sets test_address indicating a memory address as an initial value of the test start address (step S402). test_address is calculated with the following expression (1).

test_address=start_address+(arithmetic_no−1)×[memory size of NOP instruction] (1)

start_address used in the above expression is the address start_address obtained in step S302. Moreover, arithmetic_no used in the above expression is arithmetic_no obtained in step S301.

The test data setting unit 230 sets data used for the test (step S403). The data used here is the number of processors, a predicted value, predetermined test environment information, and a test number. The test instruction sequence control unit 240 specifies the test start address, and issues a test start instruction (step S404). The plurality of processors 270 execute the test instruction sequence starting at the test start address (step S405). The plurality of processors 270 transmit a result of the operation in step S405 to the test instruction sequence control unit 240. The test instruction sequence control unit 240 receives the result of the operation in step S405 from the plurality of processors 270 (step S406). The test instruction sequence control unit 240 makes a comparison between the received result of the operation and the predicted value, and outputs a result of the comparison (step S407). The test instruction sequence control unit 240 adds a memory size used to store one NOP instruction to test_address (step S408). The test instruction sequence control unit 240 increments Test_No by 1 (step S409). The test instruction sequence control unit 240 determines whether or not the number of tests is equal to or smaller than the number of processors (step S410). The test data setting unit 230 sets data used for the test (S403 if “YES” in step S410). If the determination in step S410 results in “YES”, the test data setting unit 230 sets test_address calculated in step S408, and Test_No calculated in step S409. After the process in step S403 is executed, the process in steps S404-S410 is repeated. Alternatively, if the determination in step S410 results in “NO”, the test instruction sequence control unit ends the process (END if “NO” in step S410).

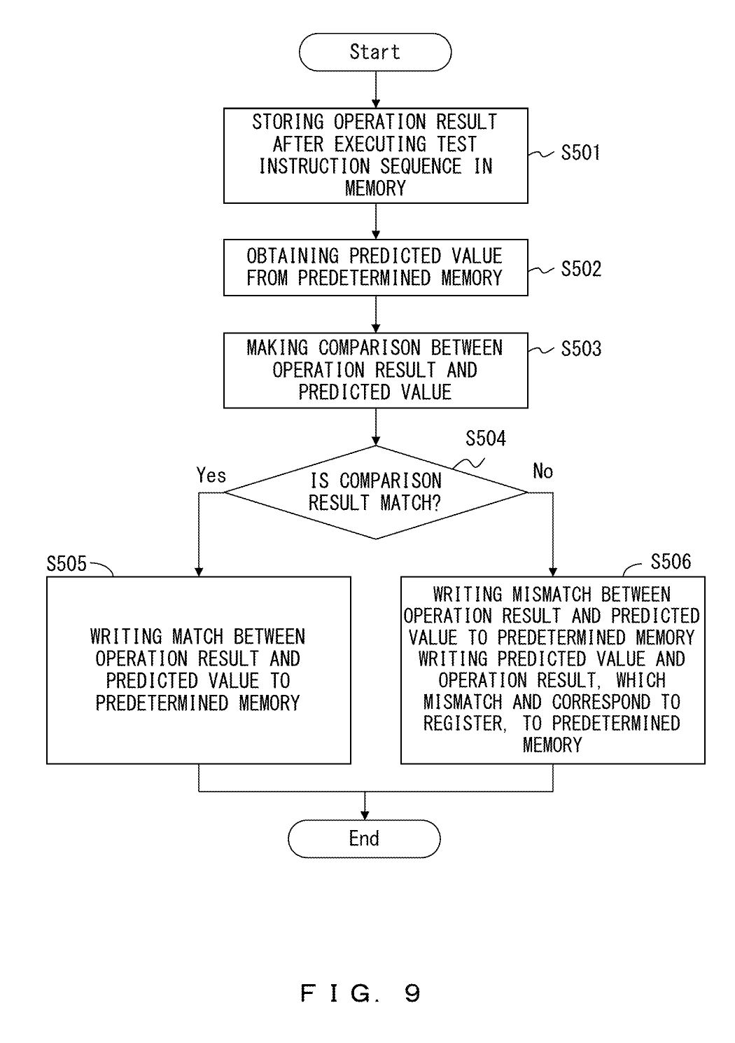

FIG. 9 is a flowchart illustrating an example of the process for making a comparison between an operation result of the test instruction sequence and a predicted value. This flowchart represents further details of the process of step S206 illustrated in FIG. 6. The test instruction sequence control unit 240 obtains a result of an operation of the test instruction sequence, and stores the obtained result in a predetermined memory (step S501). The test instruction sequence control unit 240 reads the predicted value obtained from the database 260 from the predetermined memory (step S502). Then, the test instruction sequence control unit 240 makes a comparison between the result of the operation and the predicted value (step S503). The predicted value includes a predicted value for each register according to an environment of the information processing device. The test instruction sequence control unit 240 determines whether or not the result of the operation and the predicted value match by making the comparison in step S503 (step S504). If the test instruction sequence control unit 240 determines that the result of the operation and the predicted value match, the test instruction sequence control unit 240 writes, to a predetermined memory, the match between the result of the operation and the predicted value (step S505 if “YES” in step S504). Alternatively, if the result of the operation and the predicted value mismatch, the test instruction sequence control unit 240 writes, to the predetermined memory, the mismatch between the result of the operation and the predicted value. Moreover, the test instruction sequence control unit 240 writes the predicted value and the operation result, which correspond to mismatch register, to the predetermined memory (step S506 if “NO” in step S505).

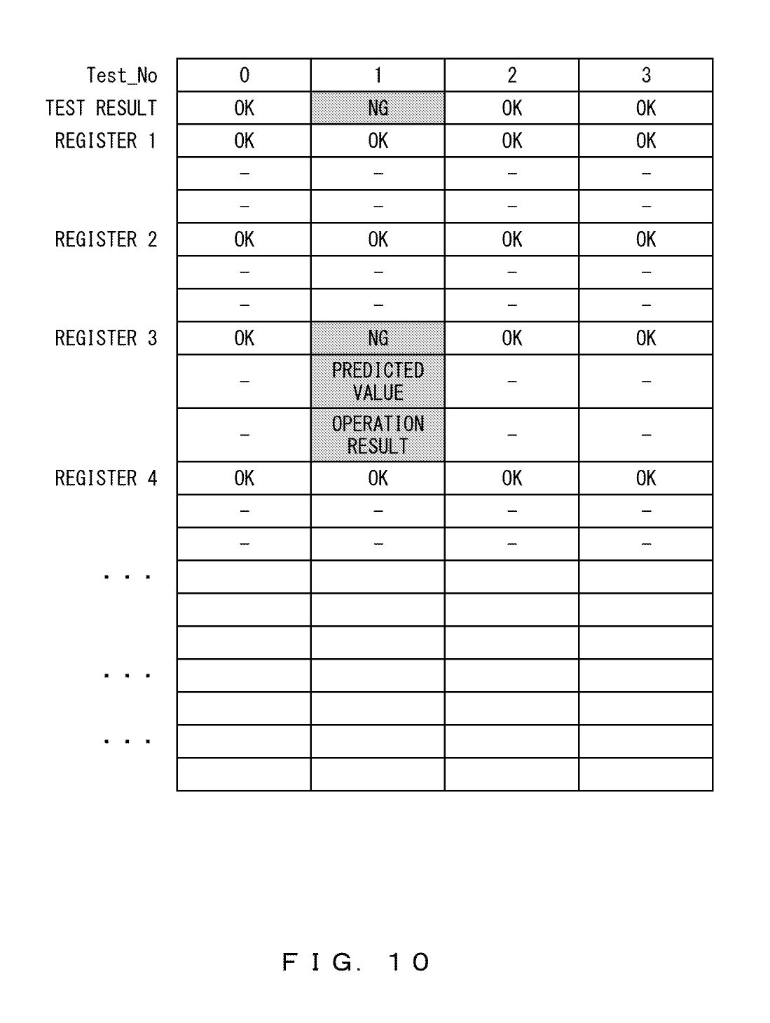

FIG. 10 illustrates an example of test result data. FIG. 10 represents the example where the test result output unit 250 displays the comparison results, which are written to the predetermined memory in steps S505 and S506, as test results. The test results illustrated in FIG. 10 include a test number in the topmost row, and a test result corresponding to each test number in the second row. In FIG. 10, also the result of the comparison in step S504 is represented for each register in association with each test number.

In step S401, 0 is set as an initial value of Test_No. In the successive tests in the patterns (i) to (iv) illustrated in FIG. 6, comparison results of the pattern (i) of the first test are displayed in a column having Test_No of 0. Comparison results of the pattern (ii) of the second test are displayed in a column having Test_No of 1, those of the pattern (iii) of the third test are displayed in a column having Test_No of 2, and those of the pattern (iv) of the fourth test are displayed in a column having Test_No of 3.

In FIG. 10, a test result is determined to be NG in the column having Test_No of 1. Checking the column having Test_No of 1, a comparison result is NG for the register 3. Moreover, the predicted value and the operation result are displayed for the register 3. An operator identifies a circuit where a fault occurs based on the displayed predicted value and operation result. If the column having Test_No of 1 is preliminarily proved to be the test in the pattern (ii) for detecting a fault in the bypass circuit between the processors C and D, the operator can identify the circuit where the fault occurs by referencing Test_No. Alternatively, if the comparison result is determined to be NG for the register 3 although the bypass circuit between the processors C and D is properly running, there is a possibility that the register 3 is damaged.

As described above, with the method according to the embodiment, an instruction sequence available for a test of a bypass circuit that connects particular processors is used as a processing instruction sequence. Moreover, an instruction sequence obtained by combining a processing instruction sequence and an instruction sequence that exerts no influence on an operation of the processing instruction sequence is generated as a test instruction sequence. Additionally, it is possible to change a bypass circuit to be tested by varying an address at which a test is started when one test instruction sequence is used. Accordingly, using the method according to the embodiment makes it possible to efficiently detect a fault of a bypass circuit between processors.

<Others>

The embodiment is not limited to the above described one, and may be variously modified. Some modification examples are described below.

The successive tests in the patterns (i) to (iv), which are represented by the flowchart of FIG. 6, are conducted sequentially from the pattern (i). However, each of the tests in the patterns (i) to (iv) may be conducted at random each time.

FIGS. 5A to 5D represent the detection of a fault in the bypass circuit between the processors A and B, the bypass circuit between the processors B and C, the bypass circuit between the processors C and D, and the bypass circuit between the processors D and A. However, other combinations of the processors are also interconnected by circuits. The examples of FIGS. 5A-5D are not intended to limit the circuits between processors, in which a fault is detected. For example, a fault in the bypass circuit between the processors A and C, and the bypass circuit between the processors B and D may be detected. In this case, for example, the processors that execute the instructions stored at the memory addresses 405 and 411 in FIG. 5A may be assumed to redundantly make an access to the same address within the register.

In step S209 of FIG. 6 and step S410 of FIG. 8, whether or not to move the process to the next step is determined by making a comparison between the number of tests and the number of processors. However, the determination criterion in step S209 of FIG. 6 and step S410 of FIG. 8 is not limited to the comparison made between the number of tests and that of processors. In step S209 of FIG. 6 and step 410 of FIG. 8, a comparison may be made between the number of tests and a predetermined threshold value. In this case, for example, the threshold value may be defined as the number of added NOP instructions.

The examples illustrated in FIGS. 1 and 5 are not intended to limit the number of processors. Additionally, the examples illustrated in FIGS. 1 and 5 are not intended to limit the number of operation instructions included in a processing instruction sequence.

All examples and conditional language provided herein are intended for pedagogical purposes to aid the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A test method for testing an apparatus including a first processor, a second processor, a third processor, a first circuit that connects the first processor and the second processor, and a second circuit that connects the second processor and the third processor, the test method comprising:
generating, by a testing processor which is one of the first to third processors or another processor, a test instruction sequence by prepending an additional instruction sequence to a certain instruction sequence which includes one or more instructions for controlling the apparatus to execute a process using the first circuit, the additional instruction sequence not changing an operation result of an instruction included in the certain instruction sequence, and the test instruction sequence including one or more instructions for controlling the apparatus to execute a process using the second circuit;
judging, by the testing processor, whether the first circuit is faulty, by controlling the apparatus to execute the test instruction sequence from a beginning of the certain instruction sequence included in the test instruction sequence; and
judging, by the testing processor, whether the second circuit is faulty, by controlling the apparatus to execute the test instruction sequence from a beginning of the additional instruction sequence included in the test instruction sequence.

2. The test method according to claim 1, wherein
the apparatus
stores a predicted value predicted to be obtained by executing the certain instruction sequence,
judges that the first circuit is faulty, when a first operation result obtained by executing the test instruction sequence from the beginning of the certain instruction sequence included in the test instruction sequence is different from the predicted value, and
judges that the second circuit is faulty, when a second operation result obtained by executing the test instruction sequence from the beginning of the additional instruction sequence included in the test instruction sequence is different from the predicted value.

3. The test method according to claim 1, wherein
the additional instruction sequence includes one or more instructions, and
the apparatus sets an address assigned to the beginning of the certain instruction sequence as an initial value of a start address from which the test instruction sequence starts to be executed,
once the apparatus completes execution of the test instruction sequence from the start address, the apparatus changes the start address to be used when the test instruction sequence is executed next, to an address obtained by subtracting a size of memory used to store one instruction which is included in the additional instruction sequence and is stored at the start address used in the completed execution of the test instruction sequence, and
the apparatus repeats execution of the test instruction sequence until a number of times that the test instruction sequence is executed reaches a predetermined threshold value equal or smaller than a number of instructions included in the additional instruction sequence.

4. The test method according to claim 1, wherein
the additional instruction sequence includes one or more instructions, and
the apparatus
sets an address assigned to the beginning of the test instruction sequence as an initial value of the start address, from which the test instruction sequence starts to be executed,
once the apparatus complete execution of the test instruction sequence from the start address, the apparatus changes the start address to be used when the test instruction sequence is executed next, to an address obtained by adding a size of memory used to store one instruction which is included in the additional instruction sequence and is stored at the start address used in the completed execution of the test instruction sequence, and
the apparatus repeats execution of the test instruction sequence until a number of times that the test instruction sequence is executed reaches a predetermined threshold value equal to or smaller than a number of instructions included in the additional instruction sequence.

5. A computer-readable recording medium having stored therein a program for causing a computer to execute a process, the computer including first to third processors, a first circuit that connects the first processor and the second processor, and a second circuit that connects the second processor and the third processor, the process comprising:
generating a test instruction sequence by prepending an additional instruction sequence to an certain instruction sequence which includes one or more instructions for controlling the computer to execute a process using the first circuit, the additional instruction sequence not changing an operation result of an instruction included in the certain instruction sequence, and the test instruction sequence including one or more instructions for controlling the computer to execute a process using the second circuit;
judging whether the first circuit is faulty, by executing the test instruction sequence from a beginning of the certain instruction sequence in the test instruction sequence; and
judging whether the second circuit is faulty, by executing the test instruction sequence from a beginning of the additional instruction sequence in the test instruction sequence.

6. An information processing apparatus comprising:
at least three processors including a first processor, a second processor, and a third processor;
a first circuit that connects the first processor and the second processor; and
a second circuit that connects the second processor and the third processor, wherein
one of the at least three processor generates a test instruction sequence by prepending an additional instruction sequence to a certain instruction sequence which includes one or more instructions for controlling the information processing apparatus to execute a process using the first circuit,
the additional instruction sequence does not change an operation result of an instruction included in the certain instruction sequence,
the test instruction sequence includes one or more instructions for controlling the information processing apparatus to execute a process using the second circuit, and
the one of the at least three processor judges whether the first circuit is faulty, by controlling the information processing apparatus to execute the test instruction sequence from a beginning of the certain instruction sequence included in the test instruction sequence, and judges whether the second circuit is faulty, by controlling the information processing apparatus to execute the test instruction sequence from a beginning of the additional instruction sequence included in the test instruction sequence.
